(19) United States
(12) Patent Application Publication
(10) Pub. No.: US 2013/0090162 A1
(43) Pub. Date: Apr. 11, 2013

(54) Match 3 Game Across Non-Coplanar Objects

(71) Applicants: Ron Shellhamer, East Brunswick, NJ (US); Rebecca Shellhamer, East Brunswick, NJ (US); Miguel Nieves, Philadelphia, PA (US)

(72) Inventors: Ron Shellhamer, East Brunswick, NJ (US); Rebecca Shellhamer, East Brunswick, NJ (US); Miguel Nieves, Philadelphia, PA (US)

(73) Assignee: DIGITAL EMBRYO, INC., East Brunswick, NJ (US)

(21) Appl. No.: 13/269,028

(22) Filed: Oct. 7, 2011

(51) Int. Cl. A63F 13/00

(52) U.S. Cl. 463/31

(57) ABSTRACT

In one embodiment, a method includes displaying an object including a set of non-coplanar faces. Each face includes a plurality of tiles where each tile includes a value in a plurality of values. An input is received to swap a first tile in the plurality of tiles with a second tile in the plurality of tiles. The method then determines if a match of more than two tiles of a same value results due to the swap. The match of more than two tiles occurs across multiple non-coplanar faces of the object. The method allows the swap if the match occurs, wherein allowing the swap includes replacing values for the more than two tiles from the multiple non-coplanar faces and disallows the swap if the match is not determined.

### BACKGROUND

Particular embodiments generally relate to match games.

With the proliferation of mobile devices, such as smart phones and tablets, games that are played on these devices have become popular. One example of a game is a “Match 3” game. These games typically include one panel of tiles that include different values, such as colors, objects, or other images. A user swaps tiles in the panel to attempt to make a match of three tiles of the same value. For example, when a match of three tiles (or more) of the same value is achieved by swapping two tiles, then the three tiles may be removed from the panel and new tiles with random values may replace the removed tiles. A user scores points by making a match and also may receive other features, such as bonuses.

Many Match 3 games on a single panel have been released. Developers attempt to provide differentiation by providing different features, graphics, and effects for the games. However, the different features that can be provided are limited and may not be as interesting anymore.

### SUMMARY

In one embodiment, a method includes displaying an object including a set of non-coplanar faces. Each face includes a plurality of tiles where each tile includes a value in a plurality of values. An input is received to swap a first tile in the plurality of tiles with a second tile in the plurality of tiles. The method then determines if a match of more than two tiles of a same value results due to the swap. The match of more than two tiles occurs across multiple non-coplanar faces of the object. The method allows the swap if the match occurs, wherein allowing the swap includes replacing values for the more than two tiles from the multiple non-coplanar faces and disallows the swap if the match is not determined.

In one embodiment, a non-transitory computer-readable storage medium is provided that contains instructions for controlling a computer system to be operable to: display an object including a set of non-coplanar faces, wherein each face includes a plurality of tiles where each tile includes a value in a plurality of values; receive an input to swap a first tile in the plurality of tiles with a second tile in the plurality of tiles; determine if a match of more than two tiles of a same value results due to the swap, wherein the match of more than two tiles occurs across multiple non-coplanar faces of the object; allow the swap if the match occurs, wherein allowing the swap includes replacing values for the more than two tiles from the multiple non-coplanar faces; and disallow the swap if the match is not determined.

In one embodiment, an apparatus includes one or more computer processors and a computer-readable storage medium comprising instructions for controlling the one or more computer processors to be operable to: display an object including a set of non-coplanar faces, wherein each face includes a plurality of tiles where each tile includes a value in a plurality of values; receive an input to swap a first tile in the plurality of tiles with a second tile in the plurality of tiles; determine if a match of more than two tiles of a same value results due to the swap, wherein the match of more than two tiles occurs across multiple non-coplanar faces of the object; allow the swap if the match occurs, wherein allowing the swap includes replacing values for the more than two tiles from the multiple non-coplanar faces; and disallow the swap if the match is not determined.

The following detailed description and accompanying drawings provide a better understanding of the nature and advantages of the present invention.

### BRIEF DESCRIPTION OF THE DRAWINGS

FIG. 1 shows an object that is used to provide a match game according to one embodiment.

FIG. 2 shows neighboring tiles in the up, right, bottom, and left directions.

FIG. 3 shows an example of neighbors of a tile that are situated on adjacent non-coplanar faces according to one embodiment.

FIG. 4 depicts a simplified flowchart of a method for traversing the object according to one embodiment.

FIG. 5 depicts a simplified flowchart of a method for determining if there is a match across multiple faces according to one embodiment.

FIG. 6A shows an object before a swap according to one embodiment.

FIG. 6B shows the result of the swap according to one embodiment.

FIG. 7 depicts an example of a computing device configured to provide the match game according to one embodiment.

FIG. 8 illustrates another example of a computing system configured with a match game across non-coplanar faces according to one embodiment.

### DETAILED DESCRIPTION

Described herein are techniques for a match game across non-coplanar sides. In the following description, for purposes of explanation, numerous examples and specific details are set forth in order to provide a thorough understanding of embodiments of the present invention. Particular embodiments as defined by the claims may include some or all of the features in these examples alone or in combination with other features described below, and may further include modifications and equivalents of the features and concepts described herein.

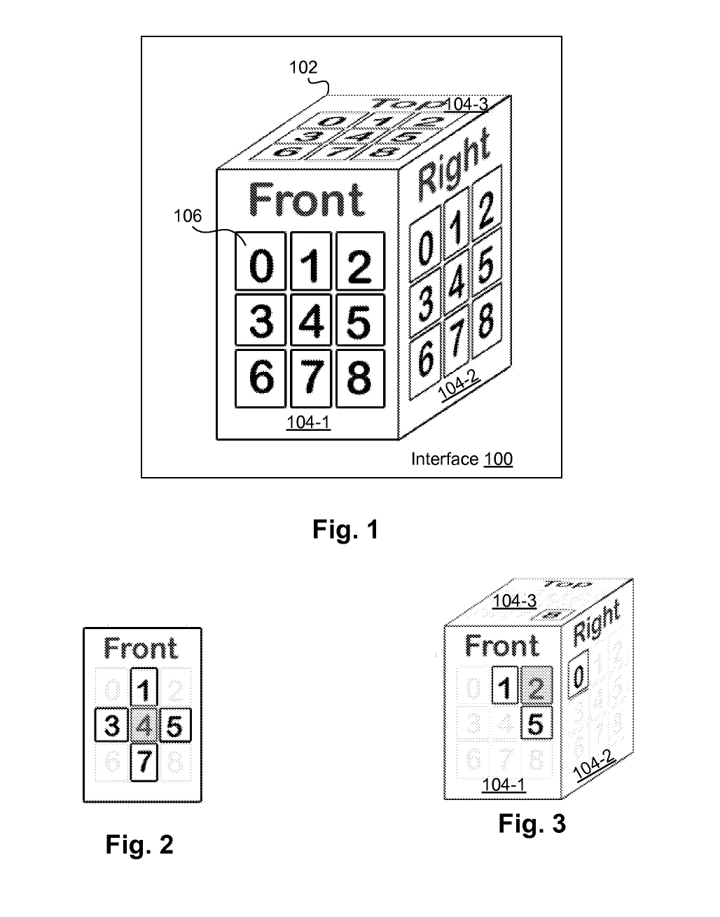

FIG. 1 shows an object 102 that is used to provide a match game according to one embodiment. An interface 100 of a device (not shown) may display object 102, which includes a plurality of faces 104. Faces 104 may form a three-dimensional (3D) object. For example, object 102 is a cube that includes six faces 104. Faces 104 may be adjacent to one another and also are non-coplanar. As shown, a front face 104-1, a right face 104-2, and a top face 104-3 are shown. Other faces 104 are not shown in FIG. 1, but include left, back, and bottom faces. Although a cube is discussed, other shapes may also be used that are three-dimensional.

Each face 104 includes a number of tiles 106. For example, nine tiles 106 are shown on each face 104 that are arranged in a 3×3 configuration. Other configurations and numbers of tiles may also be used. Each tile 106 may also include a value, such as a color or icon.

Particular embodiments allow matches to be created across multiple non-coplanar faces 104. A match across multiple non-coplanar faces 104 may be created when three or more tiles 106 of the same value form a chain across faces 104. A match may also be created on the same face 104, but is not discussed. As will be described in more detail below, a match may be across any combination of faces 104-1, 104-2, and 104-3. For example, one match may be across two faces, such as face 104-1 and face 104-2. Another match may be across more than two faces, such as faces 104-1, 104-2, and 104-3. One match may be a horizontal match, which may include tile 5 of face 104-1 and tiles 3 and 4 of face 104-2, and another match may be a vertical match, which may include tile 1 of face 104-2 and tiles 4 and 5 of face 104-3. Also, a corner match includes tiles of a corner of three faces 104, such as tile 2 of face 104-1, tile 0 of face 104-2, and tile 8 of face 104-3.

In one embodiment, a match may occur after an input is received from a user for a swap of tiles 106. For example, any tile may be swapped with one of the tile's neighbors, such as tile number 5 on face 104-1 may be swapped with tile 2 of face 104-1. Tiles 106 may also be swapped on adjacent non-coplanar faces 104, such as tile 5 of face 104-1 and tile 3 of face 104-2 may be swapped. A neighbor may be defined as shown in FIG. 2 where for a tile 4, the neighbors are adjacent tiles in the up, right, bottom, and left directions. As shown, tiles 1, 5, 7, and 3 are neighbors of tile 4. In other examples, other tiles may be considered neighbors, such as tiles 0, 2, 6, and 8 and may also be swapped with tile 4. Neighbors may also be situated on adjacent coplanar faces 104. FIG. 3 shows an example of neighbors of a tile 106 that are situated on adjacent non-coplanar faces 104 according to one embodiment. As shown, tile 2 on face 104-1 has neighbors of tile 1 and tile 5 on face 104-1. Also, tile 0 on face 104-2 and tile 8 on face 104-3 are neighbors on other non-coplanar faces 104.

A swap may be allowed when the swap results in a match of three or more tiles 106 of the same value in the horizontal, vertical, or corner directions. If a match does not occur, then the swap is not allowed and the user has to select other tiles 106 to swap. When the match occurs, an action may occur. For example, the three tiles 106 may be removed from object 102 and may be replaced with another three tiles 106 of random values. Additionally, other features may be provided, such as bonus features, referred to as power-ups, that apply other matches across object 102. These features will be described in more detail below.

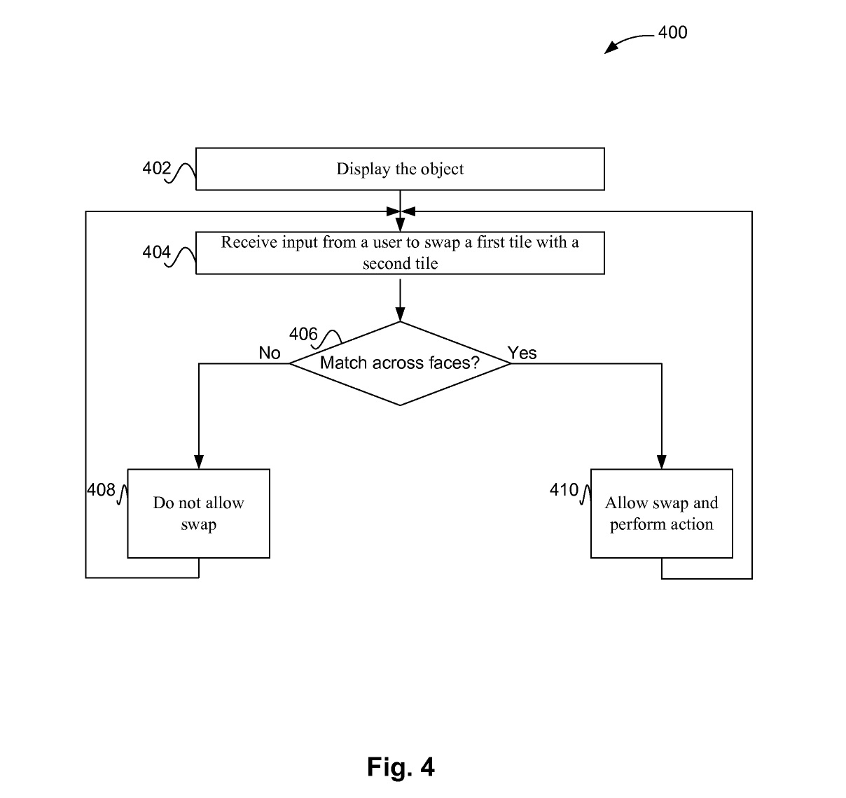

FIG. 4 depicts a simplified flowchart 400 of a method for determining a match according to one embodiment. At 402, interface 100 displays object 102. For example, a game may be started by a user and object 102 is initialized with tiles 106 of different values.

At 404, input is received from a user to swap a first tile 106 with a second tile 106. At 406, it is determined if a match across faces 104 has occurred. A match on a single face 104 may also occur, but is not discussed. If a match does not occur across multiple faces 104, at 408, the swap is not allowed. In this case, the first tile 106 and the second tile 106 remain in the same position.

At 410, if a match across faces 104 is determined, then the swap is allowed and an action is performed for the swap. For example, the tiles may be replaced with different values or other actions may be performed, such as bonus features may be provided. The process continues as other inputs to swap tiles 106 are received.

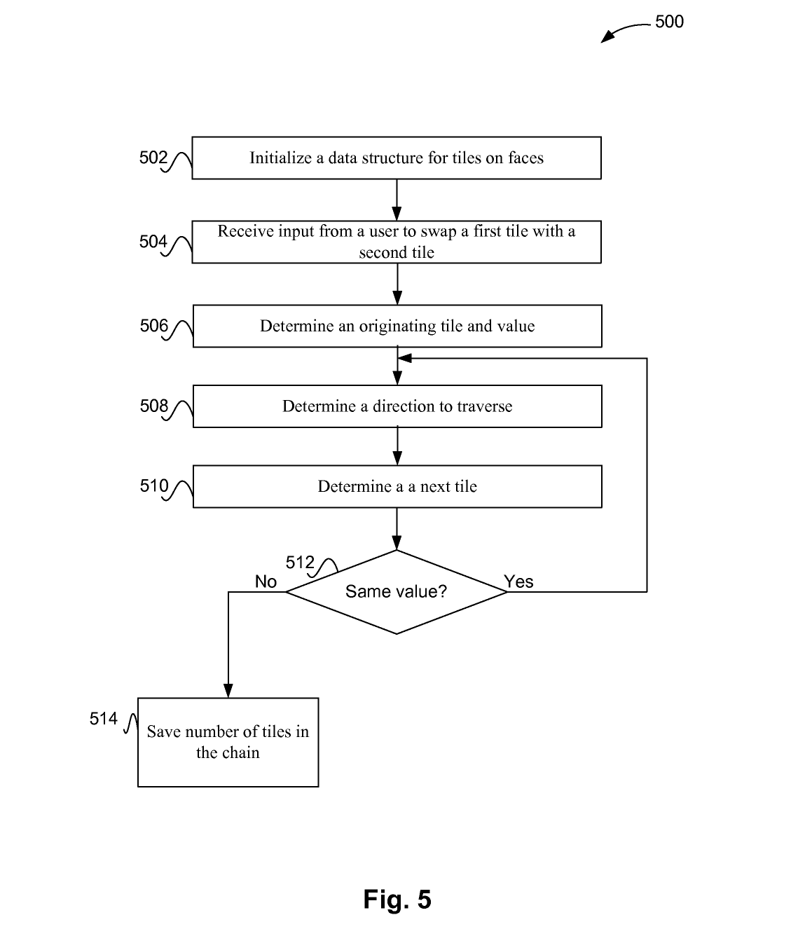

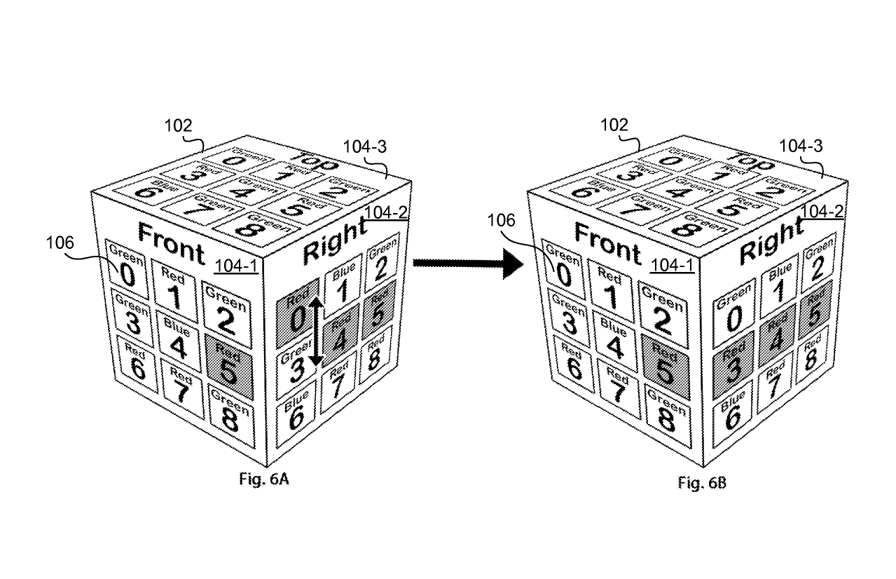

FIG. 5 depicts a simplified flowchart 500 of a method for traversing object 102 according to one embodiment. This method describes the building of chains in different directions. The chains will later be used to determine if matches occur. For example, all directions of possible neighbors for the first tile 106 and second tile 106 may be traversed to build vertical, horizontal, and corner chains. At 502, a data structure for tiles 106 on faces 104 is initialized. For example, the data structure includes a structure for each face 104. For each face 104, tiles 106 may be identified with pointers to neighboring tiles 106. Additionally, a value for each tile 106 is included in the data structure.

At 504, input for a swap of a first tile 106 and a second tile 106 is received. Referring to FIG. 6A, tile 0 and tile 3 may be swapped, which swaps the colors of the tiles. FIG. 6B shows the result of the swap where the colors for tiles 0 and 3 have been swapped. Tiles 0 and 3 are then tested to determine if any matches occur. At 506, an originating tile 106 and value are determined. The originating tile 106 may be one of the tiles 106 that have been swapped. The process described will be used to test for matches for each swapped tile 106. At 508, a direction to traverse for a current tile 106 is determined. When the traversal first starts, the originating tile 106 is the current tile 106. As the traversing continues to a subsequent tile 106, that tile becomes the current tile 106 on the reiteration. The data structure is used to determine a neighbor to a current tile 106. Then it is determined if a direction change is needed based on a position of the neighbor. For example, if the neighbor is associated with a different face ID, then a direction change is needed.

The direction to traverse may proceed in one direction until a non-matching tile is encountered. For example, a vertical direction may traverse tiles vertically. In some cases, a direction change may be necessary. For example, because faces 104 are non-coplanar, a direction change may be necessary when traversing between different faces 104. When traversing from tile 0 on the right face 104-2 to tile 8 on the top face 104-3, the direction may be changed from an up direction to a left direction. Although the traversing may be traveling visually up from tile 0 of right face 104-2, the direction needs to be changed to traverse to face 104-3. In this case, traversing from right face 104-2 to top face 104-3 requires a direction change from up to left. The direction change is needed to determine a tile 106 on a non-coplanar face 104. The direction change is used because a traversal function is configured to build a chain in a direction received as an argument to the function. If the same traversal function is used to build a chain, the direction change is used to recursively call the traversal function to cause it to continue building the chain on a non-coplanar face 104. A direction change is required when moving across certain faces to match player intent. For example, when checking a vertical match starting at tile 1 of top face 104-3, checking the up direction yields tile 1 of the bottom face, and then checking the up direction from tile 1 of the bottom face yields tile 1 of top face 104-3, creating an infinite loop. So the direction is changed to down so that tile 4 of the bottom face can be checked.

In continuing to build the chain, continuing left across face 104-3 will traverse from tile 8 to tile 7 to tile 6. When the traversal continues from top face 104-3 to the left face (not shown), a direction changes to down. The direction continues in a down direction until the traversal moves across the bottom face (not shown) where the direction changes from a down direction to a right direction. If the traversal changes from bottom face to the right face 104-2, then the direction changes from the right direction to the up direction. In one embodiment, when moving from left to right (or right to left) across faces 104, a direction change may not be needed. For example, moving from front face 104-1 to right face 104-2, the direction remains the same.

Referring back to FIG. 5, at 510, a next tile 106 is determined in the determined direction. The pointer to the neighbor tile 106 may be used to determine the next tile 106. At 512, it is determined if the next tile 106 has a same value as the originating tile 106. If the next tile 106 does not have the same value, the process proceeds to 514 to save the number and identifiers of tiles 106 in the chain.

If the next tile 106 has the same value, the process reiterates to 508 where a direction to traverse is determined again. As described above, the direction may change when traversing across faces 104. This process continues until a tile 106 that does not match the originating tile 106 is determined and the chain is built.

Once the traversal ends, the method continues for all neighboring directions for tiles 0 and 3 of face 104-2. After building all the chains, matches for the swap can be determined.

The following process may be performed to determine matches in FIG. 6B. For tile 0 of right face 104-2, a corner chain is built. The position of tile 0 is tested to determine if the tile is in a corner position. In this case, tile 0 is in a corner position of a top left position. The traversal for a corner chain then determines that a direction change is needed from up to left. This traverses to tile 8 of top face 104-3 and the value of tile 8 is tested to determine if it matches tile 0 and the values match. Then, another direction change from left to down is needed to determine the other tile for the corner match. This traverses to tile 2 of front face 104-1. Tile 2 also matches the color of tile 0 and a corner match is determined.

A vertical chain is then built from tile 0. The traversal for the vertical chain builds chains in the up and down directions. In the up direction, the traversal for the vertical chain then determines that a direction change is needed from up to left. This traverses to tile 8 of top face 104-3 and the value of tile 8 is tested to determine if it matches tile 0. Because tile 8 matches the value of tile 0, the traversal continues across top face 104-3. Tile 7 is tested and is the same value as tile 0. Then, tile 6 of top face 104-3 is tested, but is not the same value as tile 0. The result is a chain of 3. The vertical chain in the down direction is then tested. Tile 6 of right face 104-2 is tested and is not the same value. The total chain for the up and down directions is combined and a vertical chain of 3 is created.

Horizontal chains are then created. The traversal for the horizontal chain builds chains in the right and left directions. For a left horizontal chain, a direction change is needed to traverse to tile 2 of front face 104-1, where tile 2 is the same value as tile 0. Then, tile 1 of front face 104-1 is tested and is not the same value. A chain of 2 is thus built. For a right horizontal chain, tile 1 on right face 104-2 is tested and is not the same value. The total chain for the right and left directions is combined. Because the chain of 2 is only been built, a match is not determined.

For tile 3 of face 104-2, vertical chains are not built because tile 0 and tile 6 of right face 104-2 are of different values. For a left horizontal chain, a direction change is needed to traverse to tile 5 of front face 104-1, where tile 5 is the same value as tile 3. Then, tile 4 of front face 104-1 is tested and is not the same value. A chain of 2 is built. For a right horizontal chain, tile 4 on right face 104-2 is tested and is the same value. The same is true for tiles 4 and 5 of right face 104-2. It is assumed that a next tile on the back face is not the same value. The total chain for the right and left directions is combined and results in a chain of 4.

In summary, the matches determined are a horizontal match of tile 5 on front face 104-1 and tiles 3, 4, and 5 on right face 104-2 (match 4 of red colors), a corner match of tile 0 on right face 104-2, tile 8 of top face 104-3, and tile 2 of front face 104-1 (match 3 of green colors), and a vertical match of tile 0 on right face 104-2 and tiles 8 and 7 on top face 104-3 (match 3 of green colors).

The above process may be modified to determine “power-ups”, which may be bonuses that cause tiles to be matched regardless of value. One power up may match all tiles around object 102 and replaces them with different values. From an originating tile 3 of right face 104-2, a horizontal chain around object 102 is built. To determine the tiles 106 in the power up, a direction is determined, such as the right direction. Tiles 4 and 5 of right face 104-2 are added to the chain as object 102 is traversed. Then, it is determined that a new face 104 is next in the traversal. However, it is determined that a direction change is not needed as the traversal if from right face 104-2 to the back face. The traversing then continues across the back face, left face, and front face 104-1 (tiles 3, 4, and 5) to complete a chain around a row of object 102.

Another power-up builds a horizontal chain and a vertical chain regardless of value. From an originating tile 3 of right face 104-2, a vertical chain around object 102 is built. This matches all tiles around object 102 and replaces them with different values. To determine the tiles 106 in the power up, a direction is determined, such as the up direction. Tile 0 of right face 104-2 is added to the chain as object 102 is traversed. Then, it is determined that a new face 104 is next in the traversal. A direction change is needed from up to left to traverse from right face 104-2 to top face 104-3. The next tile is tile 8 of top face 104-3. Then tiles 7 and 6 of top face 104-3 are determined. The traversing then continues across the left face and bottom face to complete a chain around object 102. A direction change from left to down is needed when traversing from top face 104-3 to the left face and then a direction change from down to right is needed when traversing from the left face to the bottom face. The direction change from right to up is then needed when traversing from the bottom face to right face 104-2. A vertical chain is then completed around object 102 and combined with the horizontal chain described above.

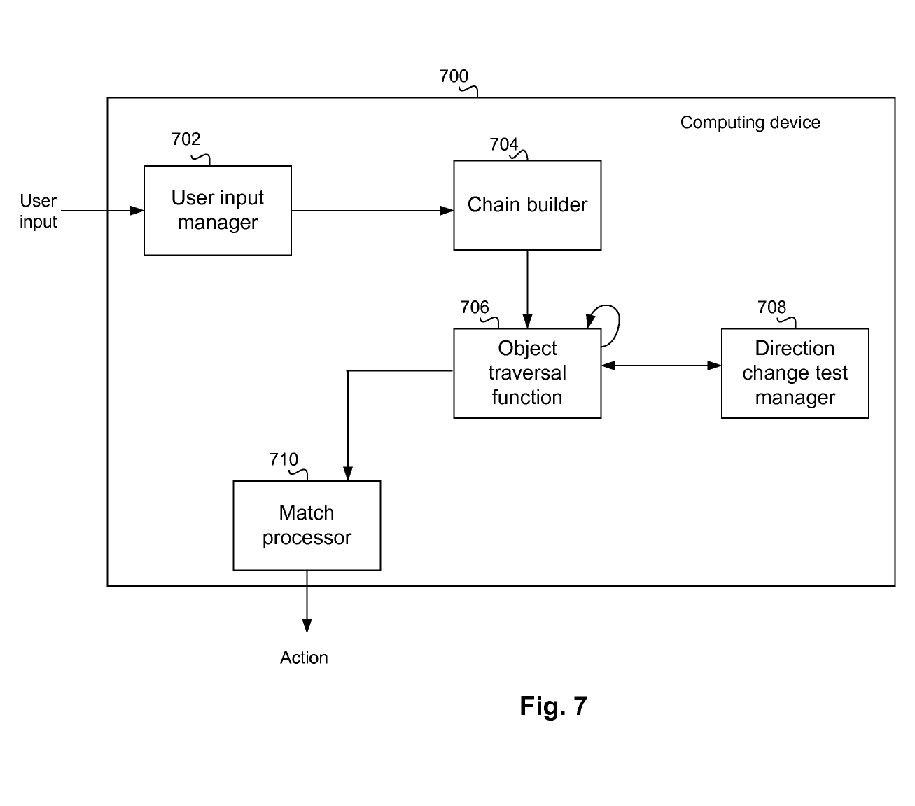

FIG. 7 depicts an example of a computing device 700 configured to provide the match game according to one embodiment. A user input manager 702 receives user input for swapping two tiles 106. Positions of the tiles 106 for the swap are passed to a chain builder 704, which coordinates the building of chains to determine which chains should be built based on the user input. For example, all directions from swapped tiles are tested. Chain builder 704 calls an object traversal function 706 to build a chain. Chain builder 704 may send an originating tile identifier and a direction to travel to build the chain.

Object traversal function 706 attempts to build a chain from the originating tile 106 in the direction received. Object traversal function 706 checks a neighbor tile 106 from a current tile 106 to see if the neighbor tile 106 has a same value. If so, the building of the chain continues. Before checking a new tile 106, object traversal function 706 needs to determine if a next tile is on a different face 104. A direction change test manager 708 is used to determine if a direction change is needed. For example, a set of conditions is sent to direction change test manager 708 to determine if a direction change is needed. For example, a current tile ID, a direction, and a current face ID are used to determine if a direction change is needed. If the current tile is tile 0 of right face 104-2 and the direction to travel is up, then direction change test manager 708 determines a direction change is needed to the left.

If a direction change is needed, object traversal function 706 is recursively called with the new direction. Object traversal function 706 is recursively called to build a chain in the new direction because neighboring tiles are on non-coplanar faces 104 of object 102. The use of direction changes designates a move to a non-coplanar face 104 for object traversal function 706. The function is configured to traverse object 102 in one direction. Because of non-coplanar faces, a direction change is used to cause object traversal function 706 to continue to build a chain on a non-coplanar face 104. Thus, a single function can be used to build chains across multiple non-coplanar faces 104. This process continues as object traversal function 706 continues to build the chain until a non-matching tile 106 is determined. The chains are then built in all directions.

A match processor 1010 then processes the chains that were built to determine an action to perform (replace the matched tiles 106) and also determine any other game play features.

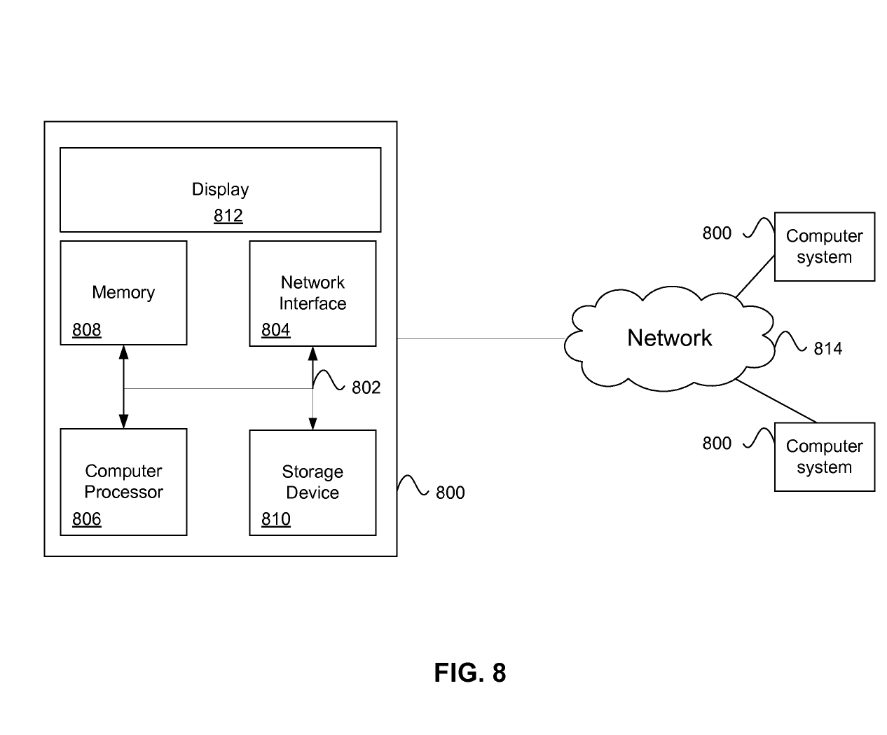

FIG. 8 illustrates another example of a computing system 800 configured with a match game across non-coplanar faces according to one embodiment. Computer system 800 includes a bus 802, network interface 804, a computer processor 806, a memory 808, a storage device 810, and a display 812.

Bus 802 may be a communication mechanism for communicating information. Computer processor 804 may execute computer programs stored in memory 808 or storage device 808. Any suitable programming language can be used to implement the routines of particular embodiments including C, C++, Java, assembly language, etc. Different programming techniques can be employed such as procedural or object oriented. The routines can execute on a single computer system 800 or multiple computer systems 800. Further, multiple processors 806 may be used.

Memory 808 may store instructions, such as source code or binary code, for performing the techniques described above. Memory 808 may also be used for storing variables or other intermediate information during execution of instructions to be executed by processor 806. Examples of memory 808 include random access memory (RAM), read only memory (ROM), or both.

Storage device 810 may also store instructions, such as source code or binary code, for performing the techniques described above. Storage device 810 may additionally store data used and manipulated by computer processor 806. For example, storage device 810 may be a database that is accessed by computer system 800. Other examples of storage device 810 include random access memory (RAM), read only memory (ROM), a hard drive, a magnetic disk, an optical disk, a CD-ROM, a DVD, a flash memory, a USB memory card, or any other medium from which a computer can read.

Memory 808 or storage device 810 may be an example of a non-transitory computer-readable storage medium for use by or in connection with computer system 800. The computer-readable storage medium contains instructions for controlling a computer system to be operable to perform functions described by particular embodiments. The instructions, when executed by one or more computer processors, may be operable to perform that which is described in particular embodiments.

Computer system 800 includes a display 812 for displaying information to a computer user. Display 812 may display a user interface used by a user to interact with computer system 800.

Computer system 800 also includes a network interface 804 to provide data communication connection over a network, such as a local area network (LAN) or wide area network (WAN). Wireless networks may also be used. In any such implementation, network interface 804 sends and receives electrical, electromagnetic, or optical signals that carry digital data streams representing various types of information.

Computer system 800 can send and receive information through network interface 804 across a network 814, which may be an Intranet or the Internet. Computer system 800 may interact with other computer systems 800 through network 814. In some examples, client-server communications occur through network 814. Also, implementations of particular embodiments may be distributed across computer systems 800 through network 814.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents may be employed without departing from the scope of the invention as defined by the claims.

What is claimed is:

1. A method comprising:
displaying an object including a set of non-coplanar faces, wherein each face includes a plurality of tiles where each tile includes a value in a plurality of values;
receiving an input to swap a first tile in the plurality of tiles with a second tile in the plurality of tiles;
determining if a match of more than two tiles of a same value results due to the swap, wherein the match of more than two tiles occurs across multiple non-coplanar faces of the object;
allowing the swap if the match occurs, wherein allowing the swap includes replacing values for the more than two tiles from the multiple non-coplanar faces; and
disallowing the swap if the match is not determined.

2. The method of claim 1, wherein the object comprises a cube with six faces.

3. The method of claim 1, wherein the match across multiple non-coplanar faces comprises a match across two adjacent non-coplanar faces in the object.

4. The method of claim 1, wherein the match across multiple non-coplanar faces comprises a match across three adjacent non-coplanar faces in the object.

5. The method of claim 1, wherein determining if the match comprises:
determining a set of neighbors for the first tile or the second tile;
traversing the object in a direction for each neighbor to determine if the match occurs in a horizontal direction or vertical direction.

6. The method of claim 1, wherein determining if the match comprises:
determining a direction to traverse from a position of the first tile or the second tile;
determining if traversing to a tile in the direction will be a tile on a different face than a face including the first tile or the second tile;
if the tile is on the different face, determining a direction change for the traversing; and
traversing in the different direction to determine the tile on the different face.

7. The method of claim 6, further comprising:
determining a value for the tile on the different face; and
determining if the value for the tile on the different face matches the value of the first tile or the second tile.

8. The method of claim 7, further comprising continuing to traverse tiles on the different face to determine additional tiles in the different direction until a value of a tile does not equal the value of the first tile or the second tile or another direction change occurs.

9. The method of claim 6, further comprising recursively calling a function with the new direction to cause the function to traverse to the different face.

10. A non-transitory computer-readable storage medium containing instructions for controlling a computer system to be operable to:
display an object including a set of non-coplanar faces, wherein each face includes a plurality of tiles where each tile includes a value in a plurality of values;
receive an input to swap a first tile in the plurality of tiles with a second tile in the plurality of tiles;
determine if a match of more than two tiles of a same value results due to the swap, wherein the match of more than two tiles occurs across multiple non-coplanar faces of the object;
allow the swap if the match occurs, wherein allowing the swap includes replacing values for the more than two tiles from the multiple non-coplanar faces; and
disallow the swap if the match is not determined.

11. The non-transitory computer-readable storage medium of claim 10, wherein the object comprises a cube with six faces.

12. The non-transitory computer-readable storage medium of claim 10, wherein the match across multiple non-coplanar faces comprises a match across two adjacent non-coplanar faces in the object.

13. The non-transitory computer-readable storage medium of claim 10, wherein the match across multiple non-coplanar faces comprises a match across three adjacent non-coplanar faces in the object.

14. The non-transitory computer-readable storage medium of claim 10, wherein determine if the match comprises:
determine a set of neighbors for the first tile or the second tile;
traverse the object in a direction for each neighbor to determine if the match occurs in a horizontal direction or vertical direction.

15. The non-transitory computer-readable storage medium of claim 10, wherein determine if the match comprises:
determine a direction to traverse from a position of the first tile or the second tile;
determine if traversing to a tile in the direction will be a tile on a different face than a face including the first tile or the second tile;
if the tile is on the different face, determine a direction change for the traversing; and
traverse in the different direction to determine the tile on the different face.

16. The non-transitory computer-readable storage medium of claim 15, further operable to:
determine a value for the tile on the different face; and
determine if the value for the tile on the different face matches the value of the first tile or the second tile.

17. The non-transitory computer-readable storage medium of claim 16, further operable continue to traverse tiles on the different face to determine additional tiles in the different direction until a value of a tile does not equal the value of the first tile or the second tile or another direction change occurs.

18. The non-transitory computer-readable storage medium of claim 15, further operable to recursively call a function with the new direction to cause the function to traverse to the different face.

19. An apparatus comprising:
one or more computer processors; and
a computer-readable storage medium comprising instructions for controlling the one or more computer processors to be operable to:
display an object including a set of non-coplanar faces, wherein each face includes a plurality of tiles where each tile includes a value in a plurality of values;
receive an input to swap a first tile in the plurality of tiles with a second tile in the plurality of tiles;
determine if a match of more than two tiles of a same value results due to the swap, wherein the match of more than two tiles occurs across multiple non-coplanar faces of the object;
allow the swap if the match occurs, wherein allowing the swap includes replacing values for the more than two tiles from the multiple non-coplanar faces; and
disallow the swap if the match is not determined.

20. The apparatus of claim 19, wherein the match across multiple non-coplanar faces comprises a match across two adjacent non-coplanar faces in the object.
